(19) United States
(12) Patent Application Publication
(10) Pub. No.: US 2026/0216947 A1
(43) Pub. Date: Jul. 30, 2026

(54) METHOD FOR MANUFACTURING OPTICAL MEMBER, MOLD FOR IMPRINTING, AND OPTICAL MEMBER

(71) Applicant: DEXERIALS CORPORATION, Tochigi (JP)

(72) Inventors: Shunsuke KANASUGI, Tochigi (JP); Shunichi KAJIYA, Tochigi (JP)

(73) Assignee: DEXERIALS CORPORATION, Tochigi (JP)

(21) Appl. No.: 19/145,201

(22) PCT Filed: Dec. 15, 2023
(86) PCT No.: PCT/JP2023/044997

§ 371 Date: Jul. 2, 2025

(30) Foreign Application Priority Data
Jan. 13, 2023 (JP) 2023-003628

(51) Int. Cl. B29C 59/02; B29C 59/04; B29L 11/00

(52) U.S. Cl. CPC B29C 59/022; B29C 59/046; B29C 2059/023; B29L 2011/0016

(57) ABSTRACT

Variation in thickness of an uncured resin layer during transfer in imprinting molding is reduced. A method for manufacturing an optical member includes a resin supply step of supplying an uncured resin composition 600 to a surface of a base material 500 of the optical member, and a transfer step of transferring a micro concave-convex structure of a mold 10 to the uncured resin composition 600. The mold 10 has a laminate structure in which a mold substrate 12, an adhesive film 14, and a film mold 16 having the micro concave-convex structure are laminated in this order. The mold substrate 12 has a thickness of more than or equal to 0.5 mm and a shore A hardness of more than or equal to 90 degrees. The adhesive film 14 is a film having adherence on both surfaces. An adhesive force of a surface of the adhesive film 14, the surface facing the film mold 16, is smaller than an adhesive force of a surface facing the mold substrate 12.

### TECHNICAL FIELD

The present invention relates to a method for manufacturing an optical member, a mold for imprinting, and an optical member.

### BACKGROUND ART

Imprinting molding for an uncured resin composition has been widely utilized as a technology for manufacturing an optical member having a micro concave-convex structure and made of resin. In imprinting molding, an uncured resin composition is supplied to a surface of a base material of an optical member, and a mold is then brought close to the uncured resin composition to press and spread the uncured resin composition between the mold and the base material of the optical member, thereby transferring a micro concave-convex structure of the mold to the uncured resin composition. Then, a layer (hereinafter referred to as an “uncured resin layer”) of the uncured resin composition to which the micro concave-convex structure has been transferred is cured.

For example, Patent Literature 1 discloses a technology for performing imprinting molding using a mold having flexibility.

### CITATION LIST

### Patent Literature

Patent Literature 1: WO 2016/051928 A1

### SUMMARY OF INVENTION

### Technical Problem

However, with the technology of Patent Literature 1 described above, it is difficult to make a pressure applied from the mold to an uncured resin composition uniform within a plane since the mold has flexibility. Therefore, variation occurs in thickness (layer thickness) of an uncured resin layer when the uncured resin composition is pressed and spread by the mold, resulting in a decrease in flatness of a post-curing resin layer (hereinafter referred to as a “cured resin layer”). Then, optical properties derived from a micro concave-convex structure transferred to the cured resin layer might decrease.

In addition, when variation occurs in thickness of the uncured resin layer, a separation force applied when the mold is separated from the cured resin layer is nonuniform within a plane of the cured resin layer. Then, part of the cured resin layer might be separated from the base material. In addition, the part of the cured resin layer separated from the base material remains on the mold, so that the mold can no longer be utilized repeatedly. Furthermore, the micro concave-convex shape transferred to the cured resin layer might be deformed when the mold is separated, so that the optical properties derived from the micro concave-convex structure might decrease.

The present invention was therefore made in view of such circumstances and has an object to provide a method for manufacturing an optical member, the method enabling variation in thickness of an uncured resin layer during transfer in imprinting molding to be reduced, a mold for imprinting, and an optical member.

### Solution to Problem

In order to solve the above-described problems, according to an aspect of the present invention, there is provided a method for manufacturing an optical member, the method including:
a resin supply step of supplying an uncured resin composition to a surface of a base material of the optical member;
a transfer step of transferring a micro concave-convex structure of a mold to the uncured resin composition, in which
the mold has a laminate structure in which a mold substrate, an adhesive film, and a film mold having the micro concave-convex structure are laminated in this order,
the mold substrate has a thickness of more than or equal to 0.5 mm and a shore A hardness of more than or equal to 90 degrees,
the adhesive film is a film having adherence on both surfaces, and
an adhesive force of a surface of the adhesive film, the surface facing the film mold, is smaller than an adhesive force of a surface facing the mold substrate.

The mold substrate may not have flexibility.

The surface of the adhesive film, the surface facing the film mold, may have re-separability and re-stickability.

In the transfer step, a pressure applied from the mold to the uncured resin composition may be more than or equal to 13 Pa and less than or equal to 2200 Pa.

In the transfer step, the film mold may be pressed against the uncured resin composition by a self-weight of the mold to transfer the micro concave-convex structure to the uncured resin composition.

The uncured resin composition may have a viscosity of more than or equal to 10 cP and less than or equal to 1000 cP at 25° C.

In the resin supply step, a first quantity of a liquid droplet of the uncured resin composition may be caused to adhere to the surface of the base material of the optical member, and a second quantity of a liquid droplet of the uncured resin composition, the second quantity being smaller than the first quantity, may also be caused to adhere to a surface of the film mold of the mold, and
in the transfer step, the mold and the base material of the optical member may be brought close to each other to bring the liquid droplet of the uncured resin composition adhering to the surface of the film mold of the mold and the liquid droplet of the uncured resin composition adhering to the surface of the base material of the optical member into contact, and the uncured resin composition may then be pressed and spread between the film mold of the mold and the base material of the optical member.

A difference between a maximum value and a minimum value of transmitted wavefront aberration of the mold substrate may be less than 4.1λ.

The difference between the maximum value and the minimum value of transmitted wavefront aberration of the mold substrate may be less than 0.8λ.

A root mean deviation of transmitted wavefront aberration of the mold substrate may be less than 1.1λ.

The root mean deviation of transmitted wavefront aberration of the mold substrate may be less than 0.15λ.

In order to solve the above-described problems, according to an aspect of the present invention, there is provided a mold for imprinting, the mold having a laminate structure in which a mold substrate, an adhesive film, and a film mold having a micro concave-convex structure are laminated in this order, in which
the mold substrate has a thickness of more than or equal to 0.5 mm and a shore A hardness of more than or equal to 90 degrees,
the adhesive film is a film having adherence on both surfaces, and
an adhesive force of a surface of the adhesive film, the surface facing the film mold, is smaller than an adhesive force of a surface facing the mold substrate.

In order to solve the above-described problems, according to an aspect of the present invention, there is provided an optical member manufactured by the above-described method for manufacturing an optical member.

### Advantageous Effects of Invention

According to the present invention, variation in thickness of an uncured resin layer during transfer in imprinting molding can be reduced.

### BRIEF DESCRIPTION OF DRAWINGS

FIG. 1 is a sectional view schematically showing a mold according to an embodiment of the present invention.

FIG. 2 is a perspective view showing an appearance example of a master according to the present embodiment.

FIG. 3 is a block diagram showing a configuration example of an exposure device according to the present embodiment.

FIG. 4 is a schematic view showing an example of a transfer device that manufactures a film mold by roll-to-roll.

FIG. 5 is a flowchart showing a flow of processing of a method for manufacturing an optical member according to the present embodiment.

FIG. 6 is a step diagram showing a resin supply step according to the present embodiment.

FIG. 7 is a first step diagram showing a transfer step according to the present embodiment.

FIG. 8 is a second step diagram showing the transfer step according to the present embodiment.

FIG. 9 is a sectional view schematically showing an optical member manufactured by the method for manufacturing an optical member according to the present embodiment.

FIG. 10 is a graph showing a relationship between a difference PV between a maximum value and a minimum value of transmitted wavefront aberration of mold substrates of Examples 1 to 3 and 6 and a difference PV between a maximum value and a minimum value of transmitted wavefront aberration of an optical member.

FIG. 11 is a graph showing a relationship between a root mean deviation Rms of transmitted wavefront aberration of the mold substrates of Examples 1 to 3 and 6 and the root mean deviation Rms of transmitted wavefront aberration of the optical member.

FIG. 12 is a graph showing a relationship between a pressure applied from the molds of Examples 1 to 3, 5, and 6 to an uncured resin composition and the difference PV between the maximum value and the minimum value of transmitted wavefront aberration of the optical member.

FIG. 13 is a graph showing a relationship between a pressure applied from the molds of Examples 1 to 3, 5, and 6 to an uncured resin composition and the root mean deviation Rms of transmitted wavefront aberration of the optical member.

### DESCRIPTION OF EMBODIMENTS

Hereinafter, preferred embodiments of the present invention will be described in detail with reference to the appended drawings. Note that in the present specification and the drawings, structural elements that have substantially the same function and structure are denoted with the same reference numerals, and repeated description is omitted. Note that for convenience of description, the state of each member to be disclosed below in the respective drawings may be schematically represented in a scale and shape different from actual ones.

### 1. Detailed Configuration of Mold

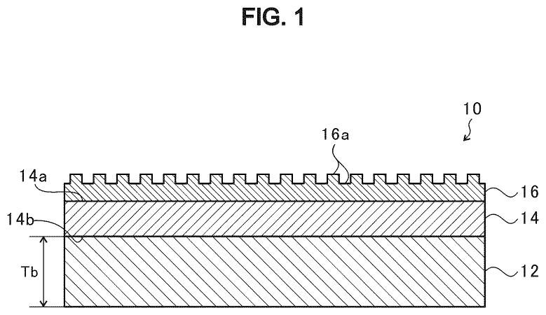

First, an overview of a mold 10 according to an embodiment of the present invention will be described with reference to FIG. 1. FIG. 1 is a sectional view schematically showing the mold 10 according to an embodiment of the present invention. As shown in FIG. 1, the mold 10 according to the present embodiment has a laminate structure in which a mold substrate 12, an adhesive film 14, and a film mold 16 are laminated in this order.

A mold substrate 12 is a substrate to be used as a base material of the mold 10. The mold substrate 12 preferably does not have flexibility. In other words, the mold substrate 12 preferably is a hard substrate having high rigidity.

The mold substrate 12 has a shore A hardness of more than or equal to 90 degrees. The mold substrate 12 preferably has a shore A hardness of more than or equal to 92 degrees, more preferably has a shore A hardness of more than or equal to 95 degrees, and still more preferably has a shore A hardness of more than or equal to 98 degrees. The mold substrate 12 may have a shore A hardness of less than or equal to 140 degrees. The mold substrate 12 may have a shore A hardness of more than or equal to 90 degrees and less than or equal to 140 degrees, preferably has a shore A hardness of more than or equal to 92 degrees and less than or equal to 140 degrees, more preferably has a shore A hardness of more than or equal to 95 degrees and less than or equal to 140 degrees, and still more preferably has a shore A hardness of more than or equal to 98 degrees and less than or equal to 140 degrees. The shore A hardness is calculated based on JIS K 6253-3:2012 “Rubber, vulcanized or thermoplastic—Determination of hardness—Part 3: Durometer method”. The shore A hardness is hardness measured by a Type A durometer. The shore A hardness is measured by “HARDMATIC HH-332 (Type A)” manufactured by Mitutoyo Corporation, for example.

The mold substrate 12 preferably is composed of glass, plastic, or metal, for example. Examples of the glass constituting the mold substrate 12 include a high transmission crown glass plate and a soda-lime glass plate, for example. The high transmission crown glass plate has a shore A hardness of 97.8. The soda-lime glass plate has a shore A hardness of 96.3. In addition, examples of the plastic constituting the mold substrate 2 include polymethylmethacrylate (PMMA), polycarbonate (PC), polyethylene terephthalate (PET), triacetylcellulose (TAC), and cycloolefin polymer (COP). Polymethylmethacrylate has a shore A hardness of 95.4. Polycarbonate has a shore A hardness of 99.0. In addition, the metal constituting the mold substrate 12 is stainless steel or iron.

Note that the mold substrate 12 preferably has transmissivity for light (ultraviolet light) in a wavelength region of more than or equal to 10 nm and less than or equal to 400 nm (for example, light in a wavelength region of 375 nm).

In addition, the shape of the mold substrate 12 may be a flat plate shape, curved shape, or spherical shape. However, in transfer step S140 which will be described later, of both surfaces of the mold substrate 12, a surface to come into contact with a transfer surface of a base material 500 of an optical member, that is, a surface of the mold substrate 12 facing the film mold 16, preferably conforms to the transfer surface of the base material 500 of the optical member. Accordingly, a pressure applied to an uncured resin composition 600 by the mold 10 in transfer step S140 can be made uniform within a plane. For example, in the case where the base material 500 of the optical member is a flat plate, the shape of the mold substrate 12 preferably is a flat plate shape.

In addition, a thickness Tb of the mold substrate 12 is more than or equal to 0.5 mm, and preferably is more than or equal to 1.0 mm. The thickness Tb of the mold substrate 12 may be less than or equal to 2.0 mm, and preferably is less than or equal to 1.5 mm. The thickness Tb of the mold substrate 12 preferably is more than or equal to 0.5 mm and less than or equal to 2.0 mm, more preferably is more than or equal to 1.0 mm and less than or equal to 2.0 mm, and still more preferably is more than or equal to 1.0 mm and less than or equal to 1.5 mm.

In addition, the mold substrate 12 preferably has excellent flatness (surface flatness). For example, a difference PV between a maximum value and a minimum value of transmitted wavefront aberration of the mold substrate 12 may be less than 4.1λ, preferably is less than 0.8λ, and more preferably is less than 0.4λ. The difference PV between the maximum value and the minimum value of transmitted wavefront aberration of the mold substrate 12 may be more than or equal to 0.1λ. The difference PV between the maximum value and the minimum value of transmitted wavefront aberration of the mold substrate 12 preferably is more than or equal to 0.1λ and less than 4.1λ, more preferably is more than or equal to 0.1λ and less than 0.8λ, and still more preferably is more than or equal to 0.1λ and less than 0.4λ. In addition, a root mean deviation Rms of transmitted wavefront aberration of the mold substrate 12 may be less than 1.1λ, preferably is less than 0.15λ, and more preferably is less than 0.10λ. The root mean deviation Rms of transmitted wavefront aberration of the mold substrate 12 may be more than or equal to 0.01λ. The root mean deviation Rms of transmitted wavefront aberration of the mold substrate 12 preferably is more than or equal to 0.01% and less than 1.1λ, more preferably is more than or equal to 0.01λ and less than 0.15λ, and still more preferably is more than or equal to 0.01λ and less than 0.10λ. Note that “2” is a wavelength of light to be used when transmitted wavefront aberration is measured and is 633 nm, for example. In addition, flatness is more excellent as the difference PV between the maximum value and the minimum value of transmitted wavefront aberration and the root mean deviation Rms are smaller.

The transmitted wavefront aberration is measured by a laser interferometer, “Verifire (registered trademark) 6” manufactured by Zygo Corporation, for example.

The adhesive film 14 is provided between the mold substrate 12 and the film mold 16. The adhesive film 14 is a film having adherence on both surfaces. An adhesive force of a surface 14a (a first surface or weak adhesive surface) of the adhesive film 14, the surface 14a facing the film mold 16, is smaller than an adhesive force of a surface 14b (a second surface or strong adhesive surface) facing the mold substrate 12.

In the present embodiment, the surface 14a of the adhesive film 14, the surface 14a facing the film mold 16, preferably has re-separability and re-stickability. The re-separability means that when the film mold 16 is separated from the adhesive film 14, separation can be achieved without the adhesive film 14 adhering to the film mold 16. The re-stickability means that even after the film mold 16 is separated from the adhesive film 14, the surface 14a of the adhesive film 14 hardly decreases in adhesive force and that the film mold 16 can be stuck again to the surface 14a of the adhesive film 14.

The adhesive film 14 preferably is a self-adhesive film. As the adhesive film 14, “FIXFILM (registered trademark) HGA2” manufactured by FUJICOPIAN CO., LTD., for example, can be used.

The film mold 16 is laminated on the adhesive film 14. The film mold 16 has a micro concave-convex structure 16a. In the present embodiment, the film mold 16 has the micro concave-convex structure 16a of more than or equal to 1 nm and less than or equal to 1000 μm, for example. Examples of the micro concave-convex structure 16a include a moth-eye structure, a microlens structure, and a diffraction optical element (DOE) structure.

### <1.1 Method for Manufacturing Film Mold>

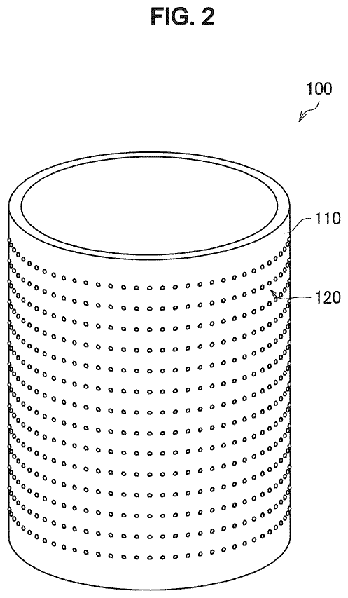

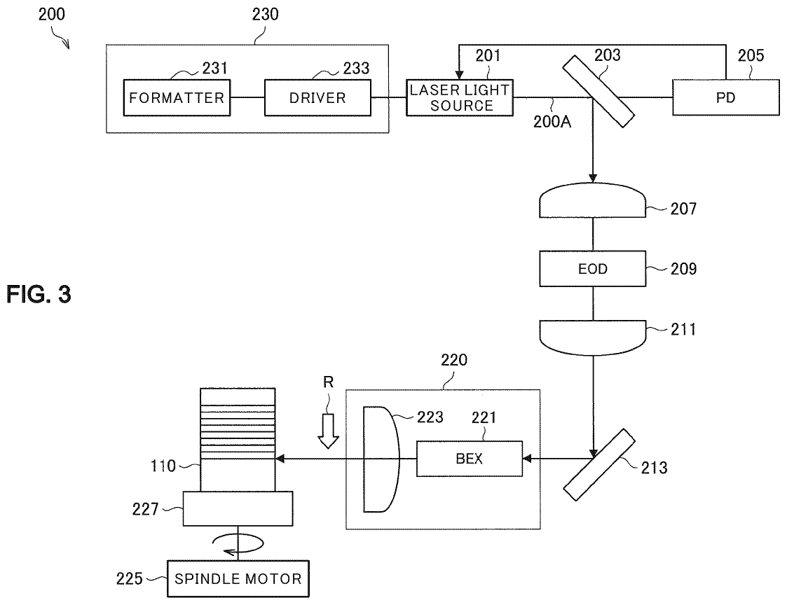

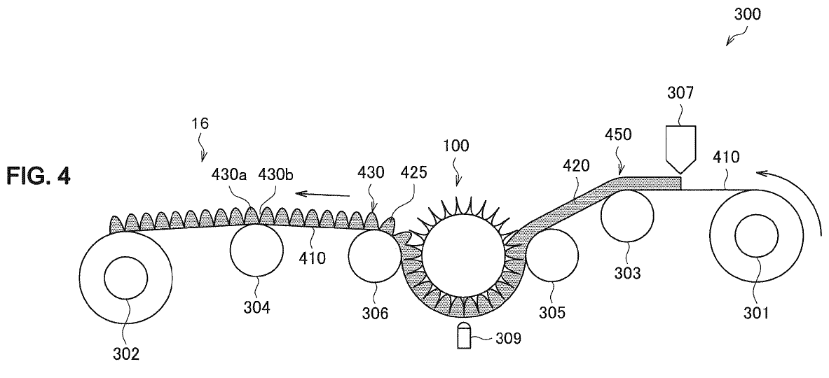

Next, a method for manufacturing the film mold 16 according to an embodiment of the present invention will be described with reference to FIG. 2 to FIG. 4. FIG. 2 is a perspective view showing an appearance example of a master 100 according to the present embodiment. FIG. 3 is a block diagram showing a configuration example of an exposure device 200 according to the present embodiment. FIG. 4 is a schematic view showing an example of a transfer device that manufactures the film mold 16 by roll-to-roll. The film mold 16 is also called a flexible master. The method for manufacturing the film mold 16 includes a first master producing step of producing a transfer mold having an inverted structure of an inverted concave-convex structure 430, a second master producing step of forming an uncured resin layer 420 on a surface of a flexible base material 410, and a third master producing step of curing the uncured resin layer 420, and transferring the concave-convex structure of the transfer mold to a resin layer 425 after curing.

### (1-1. First Master Producing Step)

The first master producing step is a step of producing a transfer mold having the inverted structure of the inverted concave-convex structure 430. The transfer mold is the master 100 shown in FIG. 2, for example.

### (1-1-1. Configuration of Master)

The configuration of the master 100 will now be described. The master 100 has a cylindrical shape. The master 100 may also have a round columnar shape, or another shape (for example, a planar shape). However, in the case in which the master 100 has a round columnar or cylindrical shape, a concave-convex structure (that is, a master concave-convex structure) 120 of the master 100 can be transferred seamlessly to a resin base material or the like by a roll-to-roll method. The inverted concave-convex structure 430 can thereby be formed on the surface of the flexible base material 410 with high production efficiency. From such a perspective, the shape of the master 100 is preferably a cylindrical shape or a round columnar shape.

The master 100 includes a master base material 110, and the master concave-convex structure 120 formed on the circumferential surface of the master base material 110. The master base material 110 is a glass body, for example, and specifically is formed from quartz glass. However, the master base material 110 is not particularly limited insofar as the SiO₂ purity is high, and may also be formed from a material such as fused quartz glass or synthetic quartz glass. The master base material 110 may also be a laminate of the above materials on a metal matrix, or a metal matrix (for example, Cu, Ni, Cr, Al). The shape of the master base material 110 is a cylindrical shape, but may also be a round columnar shape, or another shape. However, as described above, the master base material 110 preferably has a cylindrical shape or a round columnar shape. The master concave-convex structure 120 has an inverted structure of the inverted concave-convex structure 430.

### (1-1-2. Method for Manufacturing Master)

Next, a method for manufacturing the master 100 will be described. First, a base material resist layer is formed (deposited) on the master base material 110. Herein, the resist material constituting the base material resist layer is not particularly limited, and may be either an organic resist material or an inorganic resist material. Examples of organic resist materials include novolac-type resist and chemically-amplified resist. In addition, examples of inorganic resist materials include metallic oxides including one or multiple types of transition metals such as tungsten (W) or molybdenum (Mo). Other examples of inorganic resist materials include Cr, Au, and the like. However, in order to conduct thermal reaction lithography, the base material resist layer preferably is formed from a thermo-reactive resist including a metallic oxide.

In the case of using an organic resist material, the base material resist layer may be formed on the master base material 110 by using a process such as spin coating, slit coating, dip coating, spray coating, or screen printing. In addition, in the case of using an inorganic resist material for the base material resist layer, the base material resist layer may be formed using sputtering. An organic resist material and an inorganic resist material may also be used together.

Next, by exposing part of the base material resist layer with the exposure device 200 (see FIG. 3), a latent image is formed on the base material resist layer. Specifically, the exposure device 200 modulates laser light 200A, and irradiates the base material resist layer with the laser light 200A. Consequently, part of the base material resist layer irradiated with the laser light 200A denatures, and thus a latent image corresponding to the master concave-convex structure 120 may be formed in the base material resist layer.

Next, by dripping a developing solution onto the base material resist layer in which the latent image is formed, the base material resist layer is developed. Accordingly, a concave-convex structure is formed in the base material resist layer. Subsequently, by etching the master base material 110 and the base material resist layer using the base material resist layer as a mask, the master concave-convex structure 120 is formed on the master base material 110. Note that although the etching method is not particularly limited, dry etching that is vertically anisotropic is preferable. For example, reactive ion etching (RIE) is preferable. Through the above steps, the master 100 is produced. The etching may be wet etching.

### (1-1-3. Configuration of Exposure Device)

Next, the configuration of the exposure device 200 will be described on the basis of FIG. 3. The exposure device 200 is a device that exposes the base material resist layer. The exposure device 200 includes a laser light source 201, a first mirror 203, a photodiode (PD) 205, a deflecting optical system, a control mechanism 230, a second mirror 213, a movable optical table 220, a spindle motor 225, and a turntable 227. In addition, the master base material 110 is placed on the turntable 227 and is capable of rotating.

The laser light source 201 is a light source that emits the laser light 200A, and is a device such as a solid-state laser or a semiconductor laser, for example. The wavelength of the laser light 200A emitted by the laser light source 201 is not particularly limited, but may be a wavelength in the blue light band from 400 nm to 500 nm, for example. In addition, it is sufficient for the spot diameter of the laser light 200A (the diameter of the spot radiated onto the resist layer) to be smaller than the diameter of the open face of a concavity of the master concave-convex structure 120, such as approximately 200 nm, for example. The laser light 200A emitted from the laser light source 201 is controlled by the control mechanism 230.

The laser light 200A emitted from the laser light source 201 advances directly in a collimated beam, reflects off the first mirror 203, and is guided to the deflecting optical system.

The first mirror 203 is made up of a polarizing beam splitter, and has a function of reflecting one polarized component, and transmitting the other polarized component. The polarized component transmitted through the first mirror 203 is detected by the photodiode 205 and photoelectrically converted. In addition, a photodetection signal photoelectrically converted by the photodiode 205 is input into the laser light source 201, and the laser light source 201 conducts phase modulation of the laser light 200A on the basis of the input photodetection signal.

In addition, the deflecting optical system includes a condenser lens 207, an electro-optic deflector (EOD) 209, and a collimator lens 211.

In the deflecting optical system, the laser light 200A is condensed onto the electro-optic deflector 209 by the condenser lens 207. The electro-optic deflector 209 is an element capable of controlling the radiation position of the laser light 200A. With the electro-optic deflector 209, the exposure device 200 is also capable of changing the radiation position of the laser light 200A guided onto the movable optical table 220 (what is called a Wobble mechanism). After the radiation position is adjusted by the electro-optic deflector 209, the laser light 200A is converted back into a collimated beam by the collimator lens 211. The laser light 200A exiting the deflecting optical system is reflected by the second mirror 213, and guided level with and parallel to the movable optical table 220.

The movable optical table 220 includes a beam expander (BEX) 221 and an objective lens 223. The laser light 200A guided to the movable optical table 220 is shaped into a desired beam shape by the beam expander 221, and then radiated via the objective lens 223 onto the base material resist layer formed on the master base material 110. In addition, the movable optical table 220 moves by one feed pitch (track pitch) in the direction of the arrow R (feed pitch direction) every time the master base material 110 undergoes one rotation. The master base material 110 is placed on the turntable 227. The spindle motor 225 causes the turntable 227 to rotate, thereby causing the master base material 110 to rotate. Accordingly, the laser light 200A is made to scan over the base material resist layer. Herein, a latent image of the base material resist layer is formed along the scanning direction of the laser light 200A.

In addition, the control mechanism 230 includes a formatter 231 and a driver 233, and controls the radiation of the laser light 200A. The formatter 231 generates a modulation signal that controls the radiation of the laser light 200A, and the driver 233 controls the laser light source 201 on the basis of the modulation signal generated by the formatter 231. The irradiation of the master base material 110 with the laser light 200A is thereby controlled.

The formatter 231 generates a control signal for irradiating the base material resist layer with the laser light 200A, on the basis of an input image depicting an arbitrary pattern to be drawn on the base material resist layer. Specifically, first, the formatter 231 acquires an input image depicting an arbitrary draw pattern to be drawn on the base material resist layer. The input image is an image corresponding to a development of the outer circumferential surface of the base material resist layer, in which the outer circumferential surface of the base material resist layer is cut in the axial direction and expanded in a single plane. In the development view, an image corresponding to the circumferential shape of the master 100 is drawn. This image illustrates the inverted structure of the inverted concave-convex structure 430. Note that a transfer film to which the master concave-convex structure 120 of the master 100 has been transferred may be produced, and the inverted concave-convex structure 430 may be formed on the flexible base material 410 using this transfer film as a transfer mold. In this case, the master concave-convex structure 120 has the same concave-convex structure as the inverted concave-convex structure 430.

Next, the formatter 231 partitions the input image into sub-regions of a predetermined size (for example, partitions the input image into a lattice), and determines whether or not the concavity draw pattern (in other words, a pattern corresponding to the concavities of the master 100) is included in each of the sub-regions. Subsequently, the formatter 231 generates a control signal to perform control to irradiate with the laser light 200A each sub-region determined to include the concavity draw pattern. This control signal (that is, the exposure signal) preferably is synchronized with the rotation of the spindle motor 225, but does not have to be synchronized. In addition, the control signal and the rotation of the spindle motor 225 may also be resynchronized every time the master base material 110 performs one rotation. Furthermore, the driver 233 controls the output of the laser light source 201 on the basis of the control signal generated by the formatter 231. The irradiation of the base material resist layer with the laser light 200A is thereby controlled. Note that the exposure device 200 may also perform a known exposure control process, such as focus servo and positional correction of the irradiation spot of the laser light 200A. The focus servo may use the wavelength of the laser light 200A, or use another wavelength for reference.

In addition, the laser light 200A radiated from the laser light source 201 may be radiated onto the base material resist layer after being split into multiple optical systems. In this case, multiple irradiation spots are formed on the base material resist layer. In this case, when the laser light 200A emitted from one optical system reaches the latent image formed by another optical system, exposure may be ended.

Consequently, according to the present embodiment, a latent image corresponding to the draw pattern of the input image can be formed in the resist layer. Then, by developing the resist layer and using the developed resist layer as a mask to etch the master base material 110 and the base material resist layer, the master concave-convex structure 120 corresponding to the draw pattern of the input image is formed on the master base material 110. In other words, an arbitrary master concave-convex structure 120 corresponding to a draw pattern can be formed. Consequently, if a draw pattern in which the inverted structure of the inverted concave-convex structure 430 is drawn is prepared as the draw pattern, the master concave-convex structure 120 having the inverted structure of the inverted concave-convex structure 430 can be formed.

Note that the exposure device usable in the present embodiment is not limited to the exposure device 200, and any type of exposure device having functions similar to those of the exposure device 200 may be used.

### (1-1-4. Method for Forming Concave-Convex Structure Using Master)

Next, an example of a method for forming the inverted concave-convex structure 430 using the master 100 will be described with reference to FIG. 4. The inverted concave-convex structure 430 can be formed on the flexible base material 410 by a roll-to-roll transfer device 300 using the master 100. In the transfer device 300 shown in FIG. 4, the curing resin constituting the resin layer 425 is what is called an ultraviolet-curing resin. The second and third master producing steps described above are performed using the transfer device 300.

The transfer device 300 includes the master 100, a base material supply roll 301, a take-up roll 302, guide rolls 303 and 304, a nip roll 305, a separation roll 306, an applicator device 307, and a light source 309.

The base material supply roll 301 is a roll around which the long-length flexible base material 410 is wound in a roll, while the take-up roll 302 is a roll that takes up the film mold 16. In addition, the guide rolls 303 and 304 are rolls that transport the flexible base material 410. The nip roll 305 is a roll that puts the flexible base material 410 on which the uncured resin layer 420 has been laminated, or in other words a transfer film 450, in close contact with the master 100. The separation roll 306 is a roll that separates the film mold 16 from the master 100.

The applicator device 307 includes applicator means such as a coater, and applies an uncured curing resin to the flexible base material 410, and forms the uncured resin layer 420. The applicator device 307 may be a device such as a gravure coater, a wire bar coater, or a die coater, for example. In addition, the light source 309 is a light source that emits light of a wavelength at which the uncured resin can be cured, and may be a device such as an ultraviolet lamp, for example.

In the transfer device 300, first, the flexible base material 410 is delivered continuously from the base material supply roll 301 via the guide roll 303. Note that partway through the delivery, the base material supply roll 301 may also be changed to a base material supply roll 301 of a separate lot. The uncured resin is applied by the applicator device 307 to the delivered flexible base material 410, and the uncured resin layer 420 is laminated onto the flexible base material 410. The transfer film 450 is thereby prepared. The transfer film 450 is put into close contact with the master 100 by the nip roll 305. The light source 309 irradiates with ultraviolet rays the uncured resin layer 420 put in close contact with the master 100, thereby curing the uncured resin layer 420. Accordingly, the uncured resin layer 420 becomes the resin layer 425, and the master concave-convex structure 120 is transferred to the surface of the resin layer 425. In other words, the inverted structure of the master concave-convex structure 120, that is, the inverted concave-convex structure 430, is formed in the surface of the resin layer 425. Next, the flexible base material 410 in which the inverted concave-convex structure 430 is formed is separated from the master 100 by the separation roll 306. Next, the flexible base material 410 in which the inverted concave-convex structure 430 is formed is taken up by the take-up roll 302 via the guide roll 304. Note that the master 100 may be oriented vertically or oriented horizontally, and a mechanism that corrects the angle and eccentricity of the master 100 during rotation may also be provided separately. For example, an eccentric tilt mechanism may be provided in a chucking mechanism. The transfer may also be performed by pressure transfer.

In this way, in the transfer device 300, the circumferential shape of the master 100 is transferred to the transfer film 450 while transporting the transfer film 450 roll-to-roll. Accordingly, the inverted concave-convex structure 430 is formed on the flexible base material 410.

Note that in the case of using a thermoplastic resin film as the flexible base material 410, the applicator device 307 and the light source 309 become unnecessary. In this case, a heater device is disposed farther upstream than the master 100. The flexible base material 410 is heated and softened by this heater device, and thereafter, the flexible base material 410 is pressed against the master 100. Accordingly, the master concave-convex structure 120 formed on the circumferential surface of the master 100 is transferred to the flexible base material 410. Note that a film including a resin other than a thermoplastic resin may be used as the flexible base material 410, and the flexible base material 410 and a thermoplastic resin film may be laminated. In this case, the laminated film is pressed against the master 100 after being heated by the heater device. Consequently, the transfer device 300 is capable of continuously producing a transfer product in which the inverted concave-convex structure 430 is formed on the flexible base material 410.

In addition, a transfer film to which the master concave-convex structure 120 of the master 100 has been transferred may be produced, and the inverted concave-convex structure 430 may be formed on the flexible base material 410 using this transfer film as a transfer mold. A transfer film to which the concave-convex structure of the transfer film has been transferred further may also be used as a transfer mold. In this case, the master concave-convex structure 120 is formed such that the micro concave-convex structure to be formed in the resin layer 425 is an inverted concave-convex structure. In addition, the master 100 may be duplicated by electroforming, thermal transfer, or the like, and this duplicate may be used as a transfer mold. Furthermore, the shape of the master 100 is not necessarily limited to a roll shape, and may also be a planar master. Besides the method for irradiating resist with the laser light 200A, various processing methods can be selected, such as semiconductor exposure using a mask, electron beam lithography, machining, or anodic oxidation.

In addition, in order to improve mold releasability of the transfer mold, either one or both of an inorganic film and a mold release film may be deposited on a surface of this transfer mold. Particularly when a micro concave-convex structure having a width less than 1 μm is transferred, either one or both of an inorganic film and a mold release film preferably is/are deposited. Metal such as Si, SiO₂, PTM, Al, Cr, or Mo or a metal oxide thereof can be used, for example, as the inorganic film. Sputtering, evaporation, and the like can be listed as methods for depositing the inorganic film. Monomolecular fluorine can be used, for example, as the mold release film. Vapor-phase growth, such as MVD (molecular layer deposition) or ALD (atomic layer deposition), or liquid-phase deposition, such as dip coating, spin coating, brushing, or spray coating, can be utilized as a method for depositing the mold release film. Note that dip coating is most suitable in terms of continuous deposition on the film mold 16.

The film mold 16 in which the resin layer 425 having the inverted concave-convex structure 430 (the micro concave-convex structure 16a) is laminated on the flexible base material 410 is thus manufactured. That is to say, the film mold 16 has a two-layer structure in which the resin layer 425 is laminated on the flexible base material 410. The flexible base material 410 is composed of glass, polycarbonate, polyethylene terephthalate, triacetylcellulose, or cycloolefin polymer, for example. In addition, the uncured resin layers 420 is composed of an polymerizable acrylic compound or a polymerizable epoxy compound, for example.

### <1.2 Method for Manufacturing Mold>

The surface of the mold substrate 12 on which the adhesive film 14 is to be laminated is cleaned, and then the adhesive film 14 is laminated on the mold substrate 12 in such a manner that the surface 14b (strong adhesive surface) of the adhesive film 14 is stuck to the surface of the mold substrate 12. Subsequently, the film mold 16 is laminated on the adhesive film 14 in such a manner that a flat surface of the film mold 16 is stuck to the surface 14a (weak adhesive surface) of the adhesive film 14. Lamination is performed by laminate through use of a hand roller or roll lamination machine. Note that in a case where an air bubble or dust is entrapped between the adhesive film 14 and the film mold 16 when the film mold 16 is laminated on the adhesive film 14, the film mold 16 is separated from the adhesive film 14, and dust is removed by a mending tape. Then, the film mold 16 is laminated again on the adhesive film 14.

### 2. Method for Manufacturing Optical Member

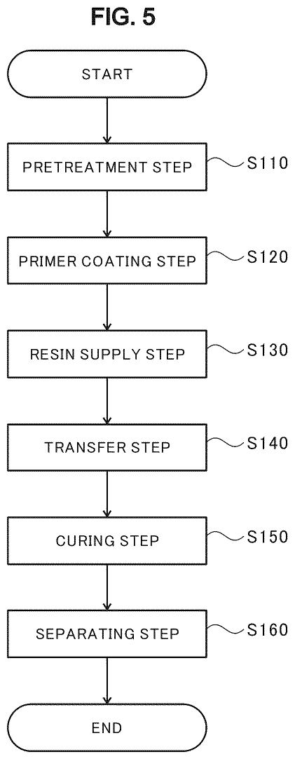

Next, a method for manufacturing an optical member according to an embodiment of the present invention will be described with reference to FIG. 5 to FIG. 9.

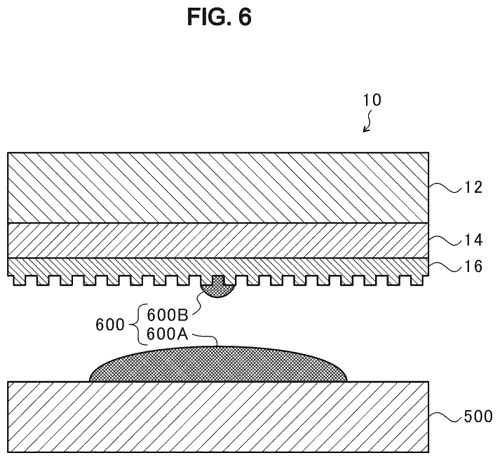

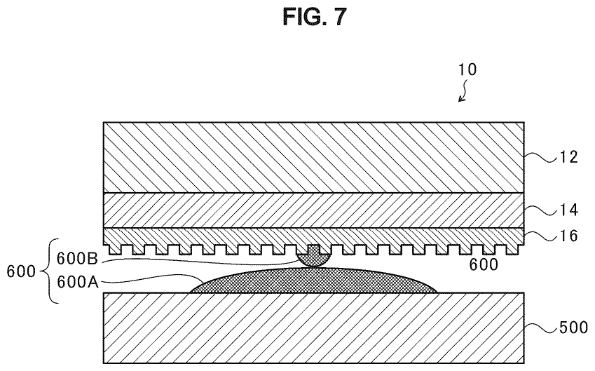

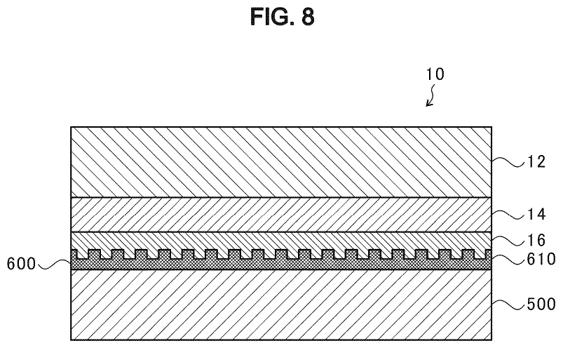

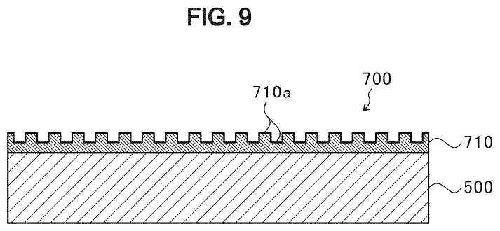

FIG. 5 is a flowchart showing a flow of processing of the method for manufacturing an optical member according to the present embodiment. FIG. 6 is a step diagram showing resin supply step S130 according to the present embodiment. FIG. 7 is a first step diagram showing transfer step S140 according to the present embodiment. FIG. 8 is a second step diagram showing transfer step S140 according to the present embodiment. FIG. 9 is a sectional view schematically showing an optical member 700 manufactured by the method for manufacturing an optical member according to the present embodiment.

As shown in FIG. 5, the method for manufacturing an optical member according to the present embodiment includes pretreatment step S110, primer coating step S120, resin supply step S130, transfer step S140, curing step S150, and separating step S160. Each step will be described below.

### (Pretreatment Step S110)

Pretreatment step S110 is a step of performing treatment for improving wettability of a surface of the base material 500 (see FIG. 5) of the optical member. The base material 500 preferably is composed of any type of glasses, polycarbonate (PC), polyethylene terephthalate (PET), triacetylcellulose (TAC), or cycloolefin polymer (COP), for example. In pretreatment step S110, excimer radiation treatment, UV ozone treatment, corona treatment, heating treatment, or the like is performed on the surface of the base material 500, for example. In the case of performing excimer radiation treatment, light having a wavelength of 172 nm preferably is radiated to the surface of the base material 500. This can improve wettability of the surface of the base material 500 in a short time. Note that pretreatment step S110 can be omitted.

### (Primer Coating Step S120)

Primer coating step S120 is a step of coating the surface of the base material 500 of the optical member with a primer. The primer improves adhesion between the base material 500 and the uncured resin composition 600 (see FIG. 5). The primer is a coupling agent such as a silane compound, for example. In primer coating step S120, the surface of the base material 500 is coated with the primer by spin coating, heated vapor treatment (vapor treatment), brushing, dip coating, spray coating, or the like. Then, the base material 500 with the surface coated with the primer is heated at a predetermined temperature for a predetermined time. Note that primer coating step S120 can be omitted.

### (Resin Supply Step S130)

Resin supply step S130 is a step of supplying the uncured resin composition 600 to the surface of the base material 500 of the optical member. The uncured resin composition 600 may have a viscosity of more than or equal to 10 cP at 25° C. The uncured resin composition 600 may have a viscosity of less than or equal to 1000 cP at 25° C. The uncured resin composition 600 preferably has a viscosity of more than or equal to 10 cP and less than or equal to 1000 cP at 25° C. Note that 1 cp can be converted into 1 mPa·s.

The uncured resin composition 600 preferably is a transparent organic material. The uncured resin composition 600 is not particularly limited, and a publicly-known organic material can be used. For example, the uncured resin composition 600 preferably is composed of a curing resin, such as any type of thermal curing resin or any type of ultraviolet curing resin, and a curing initiator because transparency can be ensured and because of excellent ease of manufacturing.

A polymerizable epoxy compound, a polymerizable acrylic compound, or the like can be used for the curing resin. A polymerizable epoxy compound is a monomer, oligomer, or prepolymer having one or two or more epoxy groups in the molecule. Examples of polymerizable epoxy compounds include various bisphenol epoxy resins (such as bisphenol A and F), novolac epoxy resin, various modified epoxy resins such as rubber and urethane, naphthalene epoxy resin, biphenyl epoxy resin, phenol novolac epoxy resin, stilbene epoxy resin, triphenol methane epoxy resin, dicyclopentadiene epoxy resin, triphenyl methane epoxy resin, their prepolymers, and the like.

A polymerizable acrylic compound is a monomer, oligomer, or prepolymer having one or two or more acrylic groups in the molecule. Herein, monomers are further classified into monofunctional monomers having one acrylic group in the molecule, bifunctional monomers having two acrylic groups in the molecule, and multifunctional monomers having three or more acrylic groups in the molecule.

Examples of “monofunctional monomers” include carboxylic acids (such as acrylic acids), hydroxy monomers (2-hydroxyethyl acrylate, 2-hydroxypropyl acrylate, 4-hydroxybutyl acrylate), alkyl or alicyclic monomers (isobutyl acrylate, t-butyl acrylate, isooctyl acrylate, lauryl acrylate, stearyl acrylate, isobornyl acrylate, cyclohexyl acrylate), other functional monomers (2-methoxyethyl acrylate, methoxyethylene glycol acrylate, 2-ethoxyethyl acrylate, tetrahydrofurfuryl acrylate, benzyl acrylate, ethyl carbitol acrylate, phenoxyethyl acrylate, N,N-dimethylamino ethyl acrylate, N,N-dimethylamino propyl acrylamide, N,N-dimethyl acrylamide, acryloyl morpholine, N-isopropyl acrylamide, N,N-diethyl acrylamide, 2-(perfluorooctyl)ethyl acrylate, 3-perfluorohexyl-2-hydroxypropyl acrylate, 3-perfluorooctyl-2-hydroxypropyl-acrylate, 2-(perfluorodecyl)ethyl-acrylate, 2-(perfluoro-3-methylbutyl)ethyl acrylate), 2,4,6-tribromophenol acrylate, 2,4,6-tribromophenol methacrylate, 2-(2,4,6-tribromophenoxy)ethyl acrylate), 2-ethylhexyl acrylate, and the like.

Examples of “bifunctional monomers” include tri(propylene glycol) di-acrylate, trimethylolpropane-diaryl ether, urethane acrylate, and the like.

Examples of “multifunctional monomers” include trimethylolpropane tri-acrylate, dipentaerythritol penta- and hexa-acrylate, ditrimethylolpropane tetra-acylate, and the like.

Examples other than the polymerizable acrylic compounds listed above include acrylmorpholine, glycerol acrylate, polyether acrylates, N-vinylformamide, N-vinylcaprolactam, ethoxy diethylene glycol acrylate, methoxy triethylene glycol acrylate, polyethylene glycol acrylate, ethoxylated trimethylolpropane tri-acrylate, ethoxylated bisphenol A di-acrylate, aliphatic urethane oligomers, polyester oligomers, and the like.

In addition, examples of the curing initiator of the curing resin described above include thermal curing initiators, light curing initiators, and the like. The curing initiator may be one that cures by some kind of an energy beam (for example, an electron beam) other than heat or light. In the case in which the curing initiator is a thermal curing initiator, the curing resin is a thermal curing resin, and in the case in which the curing initiator is a light curing initiator, the curing resin is a light curing resin.

Among them, an ultraviolet curing initiator preferably is used as the curing initiator. The ultraviolet curing initiator is a type of light curing initiator. Examples of ultraviolet curing initiators include 2,2-dimethoxy-1,2-diphenylethane-1-one, 1-hydroxy-cyclohexyl phenyl ketone, 2-hydroxy-2-methyl-1-phenyl propane-1-one, and the like. Consequently, the curing resin preferably is an ultraviolet curing resin. From the perspective of transparency, the curing resin more preferably is an ultraviolet-curing acrylic resin.

In addition, the uncured resin composition 600 may include other additives in addition to the curing resin and the curing initiator. Examples of other additives include an antioxidant, a phosphor, a plasticizer, an ultraviolet absorber, an anti-foaming agent, a thixotropic agent, a polymerization inhibitor, a mold release agent, particles of a metal oxide, and the like.

As shown in FIG. 6, in the present embodiment, a first quantity of a liquid droplet 600A of the uncured resin composition 600 is caused to adhere to the surface of the base material 500 of the optical member, and a second quantity of a liquid droplet 600B of the uncured resin composition 600, the second quantity being smaller than the first quantity, is also caused to adhere to the surface of the film mold 16 of the mold 10 in resin supply step S130.

### (Transfer Step S140)

Transfer step S140 is a step of transferring the micro concave-convex structure of the film mold 16 of the mold 10 to the uncured resin composition 600.

As shown in FIG. 7, in the present embodiment, the mold 10 and the base material 500 of the optical member are brought close to each other in transfer step S140 to bring the liquid droplet 600B of the uncured resin composition 600 adhering to the surface of the film mold 16 of the mold 10 and the liquid droplet 600A of the uncured resin composition 600 adhering to the surface of the base material 500 of the optical member into contact. As described above, the liquid droplet 600A of the uncured resin composition 600 of a quantity larger (for example, ten or more times larger) than a quantity on the surface of the film mold 16 of the mold 10 is caused to adhere to the surface of the base material 500. Therefore, the mold 10 and the base material 500 of the optical member are brought close to each other in transfer step S140, so that the liquid droplet 600A adhering to the surface of the base material 500 and the liquid droplet 600B adhering to the film mold 16 of the mold 10 are first brought into point contact.

Thereafter, the mold 10 and the base material 500 of the optical member are brought still close to each other, and the uncured resin composition 600 is pressed and spread between the film mold 16 of the mold 10 and the base material 500 of the optical member. Accordingly, a layer 610 (hereinafter referred to as “the uncured resin layer 610”) of the uncured resin composition 600 is formed between the film mold 16 of the mold 10 and the base material 500 of the optical member as shown in FIG. 8.

In addition, in order to make the thickness of the uncured resin layer 610 uniform, the pressure applied from the mold 10 to the uncured resin composition 600 in transfer step S140 may be more than or equal to 13 Pa, and preferably is more than or equal to 20 Pa. The pressure applied from the mold 10 to the uncured resin composition 600 in transfer step S140 may be less than or equal to 2200 Pa, preferably is less than or equal to 2000 Pa, and more preferably is less than or equal to 40 Pa. The pressure applied from the mold 10 to the uncured resin composition 600 in transfer step S140 preferably is more than or equal to 13 Pa and less than or equal to 2200 Pa, more preferably is more than or equal to 20 Pa and less than or equal to 2000 Pa, and still more preferably is more than or equal to 20 Pa and less than or equal to 40 Pa.

In addition, in order to simplify the device configuration, the film mold 16 preferably is pressed against the uncured resin composition 600 by a self-weight of the mold 10 in transfer step S140 to transfer the micro concave-convex structure to the uncured resin composition 600.

### (Curing Step S150)

Curing step S150 is a step of curing the uncured resin layer 610 to which the micro concave-convex structure has been transferred. In the case where the curing resin constituting the uncured resin composition 600 is a light curing resin, light (for example, ultraviolet light) is radiated to the uncured resin layer 610 in curing step S150. Alternatively, in the case where the curing resin constituting the uncured resin composition 600 is a thermal curing resin, the uncured resin layer 610 is heated in curing step S150.

### (Separating Step S160)

Separating step S160 is a step of separating the mold 10 from the cured resin layer 710 cured by performing curing step S150.

By thus performing pretreatment step S110, primer coating step S120, resin supply step S130, transfer step S140, curing step S150, and separating step S160, the optical member 700 in which the cured resin layer 710 having a micro concave-convex structure 710a is laminated on the base material 500 as shown in FIG. 9 is manufactured. The optical member 700 is an antireflection film having a moth-eye structure, a light diffusing element having a microlens structure, or a diffraction optical element, for example.

### 3. Effects

As described above, the mold 10 to be used for the method for manufacturing an optical member according to the present embodiment includes the mold substrate 12 having a thickness of more than or equal to 0.5 mm and a shore A hardness of more than or equal to 90 degrees. Accordingly, the pressure applied to the uncured resin composition 600 between the mold 10 and the base material 500 in transfer step S140 can be made uniform within a plane. This can reduce variation in thickness (layer thickness) of the uncured resin layer 610 when the uncured resin composition 600 is pressed and spread by the mold 10. Consequently, the cured resin layer 710 can have excellent flatness, and optical properties derived from the micro concave-convex structure 710a transferred to the cured resin layer 710 can be kept from decreasing. Note that the flatness means uniformity of the thickness (layer thickness) of a layer. Therefore, the expression that a layer has excellent flatness means that variation in thickness of the layer is small.

For example, in a case where the optical member 700 according to the present embodiment is employed as a cover glass of an image sensor or a sensing camera, a situation in which a contour of a subject that reaches a sensor through the cover glass is blurred can be avoided, which can prevent distortion of an image plane from occurring. Consequently, false detection by the sensor can be avoided.

In addition, since variation in thickness of the uncured resin layer 610 can be reduced, a separation force applied when the mold 10 is separated from the cured resin layer 710 in separating step S160 can be made uniform within a plane of the cured resin layer 710. Consequently, a situation in which part of the cured resin layer 710 is separated from the base material 500 can be avoided. This can keep the separated part of the cured resin layer 710 from remaining on the mold 10, which enables the mold 10 to be utilized repeatedly. In addition, since the above-described separation force can be made uniform within the plane of the cured resin layer 710, a situation in which the micro concave-convex structure 710a transferred to the cured resin layer 710 is deformed when the mold 10 is separated in separating step S160 can be avoided. Therefore, the optical properties derived from the micro concave-convex structure 710a transferred to the cured resin layer 710 can be kept from decreasing.

In addition, as described above, the mold 10 to be used for the method for manufacturing an optical member according to the present embodiment has a laminate structure in which the mold substrate 12, the adhesive film 14, and the film mold 16 having the micro concave-convex structure 16a are laminated in this order. When the adhesive film 14 is thus provided between the mold substrate 12 and the film mold 16, the pressure applied to the uncured resin composition 600 between the mold 10 and the base material 500 in transfer step S140 can be made more uniform within the plane.

In addition, as described above, the adhesive film 14 of the mold 10 to be used for the method for manufacturing an optical member according to the present embodiment is a film having adherence on both the surfaces, and an adhesive force of the surface 14a of the adhesive film 14, the surface 14a facing the film mold 16, is smaller than an adhesive force of the surface 14b facing the mold substrate 12. This enables the film mold 16 to be easily peeled from the adhesive film 14 with the mold substrate 12 being held by the adhesive film 14. Consequently, the film mold 16 can be replaced easily.

In addition, as described above, the mold 10 to be used for the method for manufacturing an optical member according to the present embodiment has the film mold 16. This enables the micro concave-convex structure 16a to be easily transferred to the base material 500 having a large area. In addition, when the mold 10 has the film mold 16, the optical member 700 can be manufactured at low cost because the film mold 16 is excellent in productivity.

In addition, as described above, the mold substrate 12 of the mold 10 to be used for the method for manufacturing an optical member according to the present embodiment preferably does not have flexibility. This can further reduce variation in thickness of the uncured resin layer 610 when the uncured resin composition 600 is pressed and spread by the mold 10 in transfer step S140.

In addition, as described above, the surface 14a of the adhesive film 14 of the mold 10 to be used for the method for manufacturing an optical member according to the present embodiment, the surface 14a facing the film mold 16, preferably has re-separability and re-stickability. This enables the film mold 16 to be replaced more easily.

In addition, as described above, the pressure applied from the mold 10 to the uncured resin composition 600 in transfer step S140 of the method for manufacturing an optical member according to the present embodiment preferably is more than or equal to 13 Pa and less than or equal to 2200 Pa. This can further reduce variation in thickness of the uncured resin layer 610 when the uncured resin composition 600 is pressed and spread by the mold 10 in transfer step S140.

In addition, as described above, the film mold 16 preferably is pressed against the uncured resin composition 600 by the self-weight of the mold 10 in transfer step S140 to transfer the micro concave-convex structure 16a to the uncured resin composition 600 in transfer step S140 of the method for manufacturing an optical member according to the present embodiment. This eliminates the need for a device dedicated for applying a pressure to the mold 10 in transfer step S140, which can simplify the device configuration. Consequently, cost required for transfer step S140 can be cut down.

In addition, as described above, the uncured resin composition 600 to be used in the method for manufacturing an optical member according to the present embodiment preferably has a viscosity of more than or equal to 10 cP and less than or equal to 1000 cP at 25° C. This can improve a follow capability of the uncured resin composition 600 to the micro concave-convex structure 16a of the film mold 16 when the uncured resin composition 600 is pressed and spread in transfer step S140. Consequently, the micro concave-convex structure 16a of the film mold 16 can be transferred evenly to the uncured resin composition 600 in transfer step S140. In addition, an air bubble can be kept from being entrapped into the uncured resin composition 600 in transfer step S140. This can avoid a situation in which part of the micro concave-convex structure 710a is broken by an air bubble in the cured resin layer 710.

In addition, as described above, in resin supply step S130 of the method for manufacturing an optical member according to the present embodiment, the first quantity of the liquid droplet 600A of the uncured resin composition 600 preferably is caused to adhere to the surface of the base material 500 of the optical member, and the second quantity of the liquid droplet 600B of the uncured resin composition 600, the second quantity being smaller than the first quantity, preferably is caused to adhere to the surface of the film mold 16 of the mold 10. Then, in transfer step S140 of the method for manufacturing an optical member according to the present embodiment, the mold 10 and the base material 500 of the optical member preferably are brought close to each other, thereby bringing the liquid droplet 600B of the uncured resin composition 600 adhering to the surface of the film mold 16 of the mold 10 and the liquid droplet 600A of the uncured resin composition 600 adhering to the surface of the base material 500 of the optical member into contact. In addition, the uncured resin composition 600 preferably is pressed and spread between the film mold 16 of the mold 10 and the base material 500 of the optical member after bringing the liquid droplet 600B and the liquid droplet 600A into contact. Accordingly, in transfer step S140, the liquid droplet 600A and the liquid droplet 600B of the resin composition 600 can be first brought into point contact between the film mold 16 and the base material 500 (see FIG. 7), and thereafter, a contact range of the liquid droplet 600A and the liquid droplet 600B can be gradually broadened to integrate the both, thereby pressing and spreading the uncured resin composition 600 between the film mold 16 and the base material 500 (see FIG. 8). This can further keep an air bubble from being entrapped into the uncured resin composition 600. Consequently, a situation in which part of the micro concave-convex structure 710a is broken by an air bubble in the cured resin layer 710 can be avoided.

In addition, as described above, the difference PV between the maximum value and the minimum value of transmitted wavefront aberration of the mold substrate 12 of the mold 10 to be used for the method for manufacturing an optical member according to the present embodiment preferably is less than 4.1λ, and more preferably is less than 1.0λ. This can further reduce variation in thickness of the uncured resin layer 610 when the uncured resin composition 600 is pressed and spread by the mold 10 in transfer step S140.

In addition, as described above, the root mean deviation Rms of transmitted wavefront aberration of the mold substrate 12 of the mold 10 to be used for the method for manufacturing an optical member according to the present embodiment preferably is less than 1.1λ, and more preferably is less than 0.2λ. This can further reduce variation in thickness of the uncured resin layer 610 when the uncured resin composition 600 is pressed and spread by the mold 10 in transfer step S140.

In addition, the cured resin layer 710 of the optical member 700 manufactured by the method for manufacturing an optical member according to the present embodiment preferably has a thickness with small variation. Accordingly, the optical member 700 can have high optical properties derived from the micro concave-convex structure 710a transferred to the cured resin layer 710.

### EXAMPLES

Next, examples of the present invention will be described. However, the examples which will be described below are specific examples to be illustrated for describing configurations, effects, and the like of the method for manufacturing an optical member, the mold for imprinting, and the optical member according to the present embodiment described above, and the present invention is not limited to the following examples.

The molds 10 of Examples 1 to 6 and Comparative Examples 1 to 2 were produced. In addition, the optical members 700 were produced using the molds 10 of Examples 1 to 6 and Comparative Examples 1 to 2.

First, the base material 500 of the optical member was wiped with a cloth impregnated with ethanol and then wiped with a dry cloth. Furthermore, the base material 500 of the optical member was blown and dried by an air gun. Then, in pretreatment step S110, excimer radiation treatment was performed on the base material 500 of the optical member for a minute. In primer coating step S120, the surface of the base material 500 of the optical member was coated with “Silane KBM-5103” manufactured by Shin-Etsu Chemical Co., Ltd. by spin coating. Then, the base material 500 with the surface coated with the primer was heated at 150° C. for five minutes. In resin supply step S130, a mixture of “acrylic UV curing resin AS08” manufactured by CHUGOKU MARINE PAINTS, LTD. and a light curing initiator was used as the uncured resin composition 600. In addition, in resin supply step S130, a dispenser manufactured by Musashi Engineering, Inc. was used to supply 65 mg of the uncured resin composition 600 to the surface of the base material 500 of the optical member and 5 mg of the uncured resin composition 600 to the surface of the film mold 16 of the mold 10. In resin supply step S130, a discharge pressure of the dispenser was 0.03 MPa, and the uncured resin composition 600 was supplied at 1 drop/sec. In curing step S150, ultraviolet light was radiated using “UV conveyor device ECS-4010X” manufactured by EYE GRAPHIC COMPANY such that a cumulative light quantity was 2000 mJ/cm². Then, separating step S160 was performed to produce optical members of Examples 1 to 6, and Comparative Examples 1 to 2.

In addition, the shore A hardnesses of the mold substrates 12 used for the molds 10 of Examples 1 to 6 and Comparative Examples 1 to 2 were measured. The shore A hardness was measured using “HARDMATIC HH-332 (Type A)” manufactured by Mitutoyo Corporation.

Transmitted wavefront aberration of the mold substrates 12 used for the molds of Examples 1 to 6 and Comparative Examples 1 to 2 as well as transmitted wavefront aberration of the optical members 700 of Examples 1 to 6 and Comparative Examples 1 to 2 were measured. The transmitted wavefront aberration was measured using the laser interferometer “Verifire (registered trademark) 6” manufactured by Zygo Corporation. A wavelength λ of laser was set at 633 nm, and output of laser was set at 3 mW. In addition, an analysis area was a square of 30 mm×30 mm. Then, the difference PV between the maximum value and the minimum value of transmitted wavefront aberration of the mold substrate 12, the root mean deviation Rms of transmitted wavefront aberration of the mold substrate 12, the difference PV between the maximum value and the minimum value of transmitted wavefront aberration of the optical member 700, and the root mean deviation Rms of transmitted wavefront aberration of the optical member 700 were calculated based on measurement results of transmitted wavefront aberration through use of the laser interferometer “Verifire (registered trademark) 6” manufactured by Zygo Corporation.

The shore A hardness of the mold substrate 12, the difference PV between the maximum value and the minimum value of transmitted wavefront aberration of the mold substrate 12, the root mean deviation Rms of transmitted wavefront aberration of the mold substrate 12, the difference PV between the maximum value and the minimum value of transmitted wavefront aberration of the optical member 700, and the root mean deviation Rms of transmitted wavefront aberration of the optical member 700 of Examples 1 to 6 and Comparative Examples 1 to 2 are shown in Table 1 below.

TABLE 1

| | Mold | | | | | | | | | |
|---|---|---|---|---|---|---|---|---|---|---|
| | Mold Substrate | | | | | | | | Optical Member | |
| | | | | Transmitted Wavefront | | | Applied | | Transmitted Wavefront | |
| | | Thickness | Shore A | Aberration | | Adhesive | Pressure | | Aberration | |
| | Material | [mm] | Hardness | PV | Rms | Film | [Pa] | | PV | Rms |
| Example 1 | PMMA | 2.0 | 95.4 | 0.831 λ | 0.194 λ | HGA2 | 25.7 | Self- | 4.319 λ | 0.828 λ |
| | | | | | | | | weight | | |
| Example 2 | High | 1.1 | 97.8 | 4.064 λ | 1.025 λ | HGA2 | 28.8 | Self- | 6.595 λ | 1.012 λ |
| | transmission | | | | | | | weight | | |
| | crown | | | | | | | | | |
| | glass plate | | | | | | | | | |
| Example 3 | Soda-lime | 1.3 | 96.3 | 0.203 λ | 0.036 λ | HGA2 | 32.8 | Self- | 1.518 λ | 0.316 λ |
| | glass plate | | | | | | | weight | | |
| Example 4 | Soda-lime | 1.3 | 96.3 | 0.203 λ | 0.036 λ | HGA2 | 2151.0 | Weight | 11.148 λ | 1.494 λ |
| | glass plate | | | | | | | added | | |
| Example 5 | PC | 1.0 | 99.0 | 0.643 λ | 0.122 λ | HGA2 | 13.5 | Self- | 13.470 λ | 2.462 λ |
| | | | | | | | | weight | | |
| Example 6 | PC | 1.0 | 99.0 | 0.643 λ | 0.122 λ | HGA2 | 39.2 | Weight | 2.013 λ | 0.386 λ |
| | | | | | | | | added | | |
| Comparative | Silicone | 5.0 | 26.4 | Unmeasurable | Unmeasurable | HGA2 | 61.0 | Self- | Unmeasurable | Unmeasurable |
| Example 1 | | | | | | | | weight | | |
| Comparative | Soda-lime | 1.3 | 96.3 | 0.203 λ | 0.036 λ | N/A | 32.8 | Self- | 22.296 λ | 4.438 λ |
| Example 2 | glass plate | | | | | | | weight | | |

### Example 1

As shown in Table 1, in the mold 10 of Example 1, the material of the mold substrate 12 was polymethylmethacrylate (PMMA). “Acrylite (registered trademark)” manufactured by Mitsubishi Chemical Corporation was used as the mold substrate 12 of PMMA. The thickness of the mold substrate 12 was set at 2.0 mm. “FIXFILM (registered trademark) HGA2” manufactured by FUJICOPIAN CO., LTD. was used as the adhesive film 14. Polyethylene terephthalate (PET) having a thickness of 125 μm was used as the flexible base material 410 of the film mold 16. In addition, the micro concave-convex structure 16a of the film mold 16 had a moth-eye structure.

In addition, in transfer step S140, the micro concave-convex structure 16a of the film mold 16 was transferred to the uncured resin composition 600 by the self-weight of the mold 10. The pressure applied from the mold 10 to the uncured resin composition 600 in transfer step S140 was 25.7 Pa.

In Example 1, the shore A hardness of the mold substrate 12 was 95.4 degrees.

In addition, in Example 1, the difference PV between the maximum value and the minimum value of transmitted wavefront aberration of the mold substrate 12 was 0.831λ, and the root mean deviation Rms of transmitted wavefront aberration of the mold substrate 12 was 0.194λ. Consequently, it was confirmed that the mold substrate 12 of Example 1 had very excellent flatness.

In addition, in Example 1, the difference PV between the maximum value and the minimum value of transmitted wavefront aberration of the optical member 700 was 4.319λ, and the root mean deviation Rms of transmitted wavefront aberration of the optical member 700 was 0.828λ.

It was confirmed from the above results that the optical member 700 of Example 1 had very excellent flatness since the mold 10 of Example 1 had the adhesive film 14 and since the mold substrate 12 had a thickness of more than or equal to 0.5 mm and a shore A hardness of more than or equal to 90 degrees, and furthermore, had very excellent flatness.

### Example 2

As shown in Table 1, in the mold 10 of Example 2, the material of the mold substrate 12 was a high transmission crown glass plate. “Hyojun Ogata Shirofuchimigaki” (a standard large crown glass slide with edges polished) manufactured by Matsunami Glass Ind., Ltd. was used as the mold substrate 12 of the high transmission crown glass plate. The thickness of the mold substrate 12 was set at 1.1 mm. The adhesive film 14 and the film mold 16 were the same as those of Example 1.

In addition, in transfer step S140, the micro concave-convex structure 16a of the film mold 16 was transferred to the uncured resin composition 600 by the self-weight of the mold 10. The pressure applied from the mold 10 to the uncured resin composition 600 in transfer step S140 was 28.8 Pa.

In Example 2, the shore A hardness of the mold substrate 12 was 97.8 degrees.

In addition, in Example 2, the difference PV between the maximum value and the minimum value of transmitted wavefront aberration of the mold substrate 12 was 4.064λ, and the root mean deviation Rms of transmitted wavefront aberration of the mold substrate 12 was 1.025λ. Consequently, it was confirmed that the mold substrate 12 of Example 2 had excellent flatness.

In addition, in Example 2, the difference PV between the maximum value and the minimum value of transmitted wavefront aberration of the optical member 700 was 6.595λ, and the root mean deviation Rms of transmitted wavefront aberration of the optical member 700 was 1.012λ.

It was confirmed from the above results that the optical member 700 of Example 2 had excellent flatness since the mold 10 of Example 2 had the adhesive film 14 and since the mold substrate 12 had a thickness of more than or equal to 0.5 mm and a shore A hardness of more than or equal to 90 degrees, and furthermore, had excellent flatness.

### Example 3

As shown in Table 1, in the mold 10 of Example 3, the material of the mold substrate 12 was a soda-lime glass plate. “Hyojun Ogata Mizukirihanashi” (a standard large soda-lime glass slide with edges unpolished) manufactured by Matsunami Glass Ind., Ltd. was used as the mold substrate 12 of the soda-lime glass plate. The thickness of the mold substrate 12 was set at 1.3 mm. The adhesive film 14 and the film mold 16 were the same as those of Example 1.

In addition, in transfer step S140, the micro concave-convex structure 16a of the film mold 16 was transferred to the uncured resin composition 600 by the self-weight of the mold 10. The pressure applied from the mold 10 to the uncured resin composition 600 in transfer step S140 was 32.8 Pa.

In Example 3, the shore A hardness of the mold substrate 12 was 96.3 degrees.

In addition, in Example 3, the difference PV between the maximum value and the minimum value of transmitted wavefront aberration of the mold substrate 12 was 0.203λ, and the root mean deviation Rms of transmitted wavefront aberration of the mold substrate 12 was 0.036λ. Consequently, it was confirmed that the mold substrate 12 of Example 3 had extremely excellent flatness.

In addition, in Example 3, the difference PV between the maximum value and the minimum value of transmitted wavefront aberration of the optical member 700 was 1.518λ, and the root mean deviation Rms of transmitted wavefront aberration of the optical member 700 was 0.316λ.

It was confirmed from the above results that the optical member 700 of Example 3 had extremely excellent flatness since the mold 10 of Example 3 had the adhesive film 14 and since the mold substrate 12 had a thickness of more than or equal to 0.5 mm and a shore A hardness of more than or equal to 90 degrees, and furthermore, had extremely excellent flatness.

### Example 4

As shown in Table 1, the mold 10 of Example 4 was the same as the mold 10 of Example 3. In Example 4, a weight was added to the mold 10 in transfer step S140 unlike Example 3. The pressure applied from the mold 10 to the uncured resin composition 600 in transfer step S140 of Example 4 was 2151.0 Pa.

In Example 4, the difference PV between the maximum value and the minimum value of transmitted wavefront aberration of the optical member 700 was 11.148λ, and the root mean deviation Rms of transmitted wavefront aberration of the optical member 700 was 1.494λ.

It is assumed from the above results that flatness of the optical member 700 of Example 4 lowered relative to that of Example 3 since the pressure applied from the mold 10 to the uncured resin composition 600 in transfer step S140 in Example 4 was higher than in Example 3.

### Example 5

As shown in Table 1, in the mold 10 of Example 5, the material of the mold substrate 12 was polycarbonate (PC). “TECHNOLLOY (registered trademark) C000” manufactured by Escarbo Sheet Company, Ltd. was used as the mold substrate 12 of PC. The thickness of the mold substrate 12 was set at 1.0 mm. The adhesive film 14 and the film mold 16 were the same as those of Example 1.

In addition, in transfer step S140, the micro concave-convex structure 16a of the film mold 16 was transferred to the uncured resin composition 600 by the self-weight of the mold 10. The pressure applied from the mold 10 to the uncured resin composition 600 in transfer step S140 was 13.5 Pa.

In Example 5, the shore A hardness of the mold substrate 12 was 99.0 degrees.

In addition, in Example 5, the difference PV between the maximum value and the minimum value of transmitted wavefront aberration of the mold substrate 12 was 0.643λ, and the root mean deviation Rms of transmitted wavefront aberration of the mold substrate 12 was 0.122λ. Consequently, it was confirmed that the mold substrate 12 of Example 5 had very excellent flatness.

In addition, in Example 5, the difference PV between the maximum value and the minimum value of transmitted wavefront aberration of the optical member 700 was 13.470λ, and the root mean deviation Rms of transmitted wavefront aberration of the optical member 700 was 2.462λ.

It was confirmed from the above results that the optical member 700 of Example 5 had excellent flatness since the mold 10 of Example 5 had the adhesive film 14 and since the mold substrate 12 had a thickness of more than or equal to 0.5 mm and a shore A hardness of more than or equal to 90 degrees, and furthermore, had very excellent flatness.

### Example 6

As shown in Table 1, the mold 10 of Example 6 was the same as the mold 10 of Example 5. In Example 6, a weight was added to the mold 10 in transfer step S140 unlike Example 5. The pressure applied from the mold 10 to the uncured resin composition 600 in transfer step S140 of Example 6 was 39.2 Pa.

In Example 6, the difference PV between the maximum value and the minimum value of transmitted wavefront aberration of the optical member 700 was 2.013λ, and the root mean deviation Rms of transmitted wavefront aberration of the optical member 700 was 0.386λ. It was confirmed that the optical member 700 of Example 6 had very excellent flatness.

It is assumed from the above results that flatness of the optical member 700 of Example 6 was improved relative to that of Example 5 since the pressure applied from the mold 10 to the uncured resin composition 600 in transfer step S140 in Example 6 was higher than in Example 5.

### Comparative Example 1

As shown in Table 1, in the mold 10 of Comparative Example 1, the material of the mold substrate 12 was silicone. Silicone manufactured by SK CO., LTD. was used as the mold substrate 12 of silicone. The thickness of the mold substrate 12 was set at 5.0 mm. The adhesive film 14 and the film mold 16 were the same as those of Example 1.

In addition, in transfer step S140, the micro concave-convex structure 16a of the film mold 16 was transferred to the uncured resin composition 600 by the self-weight of the mold 10. The pressure applied from the mold 10 to the uncured resin composition 600 in transfer step S140 was 61.0 Pa.

In Comparative Example 1, the shore A hardness of the mold substrate 12 was 26.4 degrees.

In addition, in Comparative Example 1, the difference PV between the maximum value and the minimum value of transmitted wavefront aberration of the mold substrate 12 and the root mean deviation Rms of transmitted wavefront aberration of the mold substrate 12 were not able to be measured. Consequently, it was confirmed that the mold substrate 12 of Comparative Example 1 had very poor flatness. That is to say, it was confirmed that the thickness of the mold substrate 12 of Comparative Example 1 had very large variation.

In addition, in Comparative Example 1, neither the difference PV between the maximum value and the minimum value of transmitted wavefront aberration of the optical member 700 nor the root mean deviation Rms of transmitted wavefront aberration of the optical member 700 were able to be measured.

It was confirmed from the above results that the optical member 700 of Comparative Example 1 had very poor flatness since the mold substrate 12 of the mold of Comparative Example 1 had extremely low shore A hardness. That is to say, it was confirmed that the thickness of the optical member 700 of Comparative Example 1 had very large variation.

### Comparative Example 2

As shown in Table 1, in the mold 10 of Comparative Example 2, the material of the mold substrate 12 and the film mold 16 were the same as those of Example 3. The mold 10 of Comparative Example 2 did not include the adhesive film 14 unlike the mold 10 of Example 3.

In Comparative Example 2, in transfer step S140, the micro concave-convex structure 16a of the film mold 16 was transferred to the uncured resin composition 600 by the self-weight of the mold 10 similarly to Example 3.

In Comparative Example 2, the difference PV between the maximum value and the minimum value of transmitted wavefront aberration of the optical member 700 was 22.296λ, and the root mean deviation Rms of transmitted wavefront aberration of the optical member 700 was 4.438λ.

It was confirmed from the above results that the optical member 700 of Comparative Example 2 had poor flatness since the mold 10 of Comparative Example 2 did not have the adhesive film 14. That is to say, it was confirmed that the thickness of the optical member 700 of Comparative Example 2 had large variation.

<Study about Relationship Between Flatness of Mold Substrate 12 and Flatness of Optical Member 700>

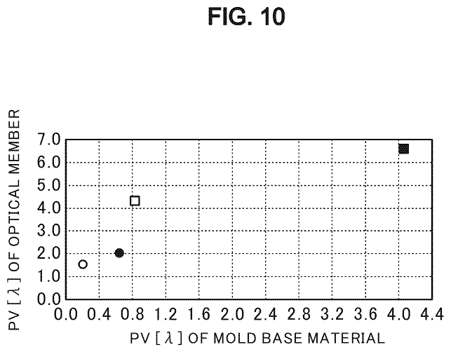

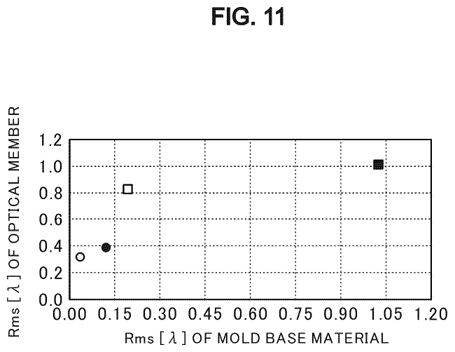

FIG. 10 is a graph showing a relationship between the difference PV between the maximum value and the minimum value of transmitted wavefront aberration of the mold substrates 12 of Examples 1 to 3 and 6 and the difference PV between the maximum value and the minimum value of transmitted wavefront aberration of the optical member 700. FIG. 11 is a graph showing a relationship between the root mean deviation Rms of transmitted wavefront aberration of the mold substrates 12 of Examples 1 to 3 and 6 and the root mean deviation Rms of transmitted wavefront aberration of the optical member 700. In FIG. 10, the horizontal axis indicates the difference PV [2] between the maximum value and the minimum value of transmitted wavefront aberration of the mold substrate 12, and the vertical axis indicates the difference PV [2] between the maximum value and the minimum value of transmitted wavefront aberration of the optical member 700. In FIG. 11, the horizontal axis indicates the root mean deviation Rms [2] of transmitted wavefront aberration of the mold substrate 12, and the vertical axis indicates the root mean deviation Rms [2] of transmitted wavefront aberration of the optical member 700. In addition, in FIG. 10 and FIG. 11, a hollow rectangle indicates Example 1, a solid rectangle indicates Example 2, a hollow circle indicates Example 3, and a solid circle indicates Example 6.

As shown in FIG. 10, it was confirmed that as the difference PV between the maximum value and the minimum value of transmitted wavefront aberration of the mold substrate 12 was smaller, the difference PV between the maximum value and the minimum value of transmitted wavefront aberration of the optical member 700 was also smaller. In addition, it was confirmed that when the difference PV between the maximum value and the minimum value of transmitted wavefront aberration of the mold substrate 12 was less than 0.8λ, the difference PV between the maximum value and the minimum value of transmitted wavefront aberration of the optical member 700 was as small as less than 3.0λ.

As shown in FIG. 11, it was confirmed that as the root mean deviation Rms of transmitted wavefront aberration of the mold substrate 12 was smaller, the root mean deviation Rms of transmitted wavefront aberration of the optical member 700 was also smaller. In addition, it was confirmed that when the root mean deviation Rms of transmitted wavefront aberration of the mold substrate 12 was less than 0.15λ, the root mean deviation Rms of transmitted wavefront aberration of the optical member 700 was as small as less than 0.6λ.

<Study about Relationship Between Pressure Applied from Mold 10 to Uncured Resin Composition 600 and Flatness of Optical Member 700>

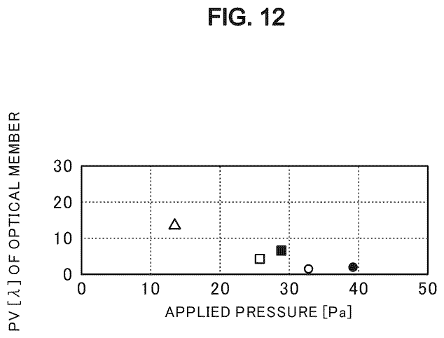

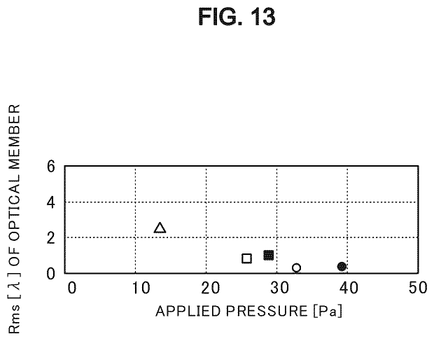

FIG. 12 is a graph showing a relationship between the pressure applied from the molds 10 of Examples 1 to 3, 5, and 6 to the uncured resin composition 600 and the difference PV between the maximum value and the minimum value of transmitted wavefront aberration of the optical member 700. FIG. 13 is a graph showing a relationship between the pressure applied from the molds 10 of Examples 1 to 3, 5, and 6 to the uncured resin composition 600 and the root mean deviation Rms of transmitted wavefront aberration of the optical member 700. In FIG. 12, the horizontal axis indicates the applied pressure [Pa], and the vertical axis indicates the difference PV [λ] between the maximum value and the minimum value of transmitted wavefront aberration of the optical member 700. In FIG. 13, the horizontal axis indicates the applied pressure [Pa], and the vertical axis indicates the root mean deviation Rms [λ] of transmitted wavefront aberration of the optical member 700. In addition, in FIG. 12 and FIG. 13, a hollow rectangle indicates Example 1, a solid rectangle indicates Example 2, a hollow circle indicates Example 3, a hollow triangle indicates Example 5, and a solid circle indicates Example 6.

As shown in FIG. 12, it was confirmed that the difference PV between the maximum value and the minimum value of transmitted wavefront aberration of the optical member 700 was as small as less than 10.0% in a range where the applied pressure was more than or equal to 20 Pa and less than or equal to 40 Pa. In addition, it was confirmed that the difference PV between the maximum value and the minimum value of transmitted wavefront aberration of the optical member 700 was as extremely small as less than 2.1λ in a range where the applied pressure was more than or equal to 30 Pa and less than or equal to 40 Pa.

As shown in FIG. 13, it was confirmed that the root mean deviation Rms of transmitted wavefront aberration of the optical member 700 was less than 1.1λ in the range where the applied pressure was more than or equal to 20 Pa and less than or equal to 40 Pa. In addition, it was confirmed that the root mean deviation Rms of transmitted wavefront aberration of the optical member 700 was as small as less than less than 0.4λ in the range where the applied pressure was more than or equal to 30 Pa and less than or equal to 40 Pa.

The preferred embodiment(s) of the present invention has/have been described above in detail with reference to the accompanying drawings, whilst the present invention is not limited to the above examples. It is obvious that a person with ordinary knowledge in the technical field to which the present invention belongs may find various alterations and modifications within the scope of technical idea recited in the claims, and it should be understood that they will naturally come under the technical scope of the present invention.

For example, in the above-described embodiment, an ultraviolet curing resin and a thermal curing resin have been cited as examples of the uncured resin composition 600. However, the uncured resin composition 600 may be a composition of another curing resin such as a solvent dried curing resin or mixed curing resin, for example.

### REFERENCE SIGNS LIST

10 mold
12 mold substrate
14 adhesive film
14a surface
14b surface
16 film mold
16a micro concave-convex structure
500 base material
600 uncured resin composition
600A liquid droplet
600B liquid droplet
700 optical member

1. A method for manufacturing an optical member, the method comprising:
a resin supply step of supplying an uncured resin composition to a surface of a base material of the optical member;
a transfer step of transferring a micro concave-convex structure of a mold to the uncured resin composition, wherein
the mold has a laminate structure in which a mold substrate, an adhesive film, and a film mold having the micro concave-convex structure are laminated in this order,
the mold substrate has a thickness of more than or equal to 0.5 mm and a shore A hardness of more than or equal to 90 degrees,
the adhesive film is a film having adherence on both surfaces, and
an adhesive force of a surface of the adhesive film, the surface facing the film mold, is smaller than an adhesive force of a surface facing the mold substrate.

2. The method for manufacturing an optical member according to claim 1, wherein the mold substrate does not have flexibility.

3. The method for manufacturing an optical member according to claim 1, wherein the surface of the adhesive film, the surface facing the film mold, has re-separability and re-stickability.

4. The method for manufacturing an optical member according to claim 1, wherein in the transfer step, a pressure applied from the mold to the uncured resin composition is more than or equal to 13 Pa and less than or equal to 2200 Pa.

5. The method for manufacturing an optical member according to claim 4, wherein in the transfer step, the film mold is pressed against the uncured resin composition by a self-weight of the mold to transfer the micro concave-convex structure to the uncured resin composition.

6. The method for manufacturing an optical member according to claim 1, wherein the uncured resin composition has a viscosity of more than or equal to 10 cP and less than or equal to 1000 cP at 25° C.

7. The method for manufacturing an optical member according to claim 1, wherein
in the resin supply step, a first quantity of a liquid droplet of the uncured resin composition is caused to adhere to the surface of the base material of the optical member, and a second quantity of a liquid droplet of the uncured resin composition, the second quantity being smaller than the first quantity, is also caused to adhere to a surface of the film mold of the mold, and
in the transfer step, the mold and the base material of the optical member are brought close to each other to bring the liquid droplet of the uncured resin composition adhering to the surface of the film mold of the mold and the liquid droplet of the uncured resin composition adhering to the surface of the base material of the optical member into contact, and the uncured resin composition is then pressed and spread between the film mold of the mold and the base material of the optical member.

8. The method for manufacturing an optical member according to claim 1, wherein a difference between a maximum value and a minimum value of transmitted wavefront aberration of the mold substrate is less than 4.1λ.

9. The method for manufacturing an optical member according to claim 8, wherein the difference between the maximum value and the minimum value of transmitted wavefront aberration of the mold substrate is less than 0.8λ.

10. The method for manufacturing an optical member according to claim 1, wherein a root mean deviation of transmitted wavefront aberration of the mold substrate is less than 1.1λ.

11. The method for manufacturing an optical member according to claim 10, wherein the root mean deviation of transmitted wavefront aberration of the mold substrate is less than 0.15λ.

12. A mold for imprinting, the mold having a laminate structure in which a mold substrate, an adhesive film, and a film mold having a micro concave-convex structure are laminated in this order, wherein
the mold substrate has a thickness of more than or equal to 0.5 mm and a shore A hardness of more than or equal to 90 degrees,
the adhesive film is a film having adherence on both surfaces, and
an adhesive force of a surface of the adhesive film, the surface facing the film mold, is smaller than an adhesive force of a surface facing the mold substrate.

13. An optical member manufactured by the method for manufacturing an optical member according to claim 1.
